(19) United States
(12) Patent Application Publication
(10) Pub. No.: US 2026/0254158 A1
(43) Pub. Date: Aug. 27, 2026

(54) WIRE STRAIN RELIEF SYSTEMS

(71) Applicant: Snap-on Incorporated, Kenosha, WI (US)

(72) Inventors: David A. Cyborski, Gurnee, IL (US); Jason S. Genz, Oak Creek, WI (US); John Dabbeekeh, Zion, IL (US)

(73) Assignee: Snap-on Incorporated, Kenosha, WI (US)

(21) Appl. No.: 19/061,694

(22) Filed: Feb. 24, 2025

(51) Int. Cl. H01R 13/58

(52) U.S. Cl. CPC H01R 13/5837

(57) ABSTRACT

A wire strain relief system adapted to support wires in a terminal block. A wire may be retained and supported by the wire strain relief system. By retaining and supporting the wire, stress and/or strain on the wire and a connection joint between a terminal and the wire may be reduced, compared to terminal blocks without wire strain relief systems.

### TECHNICAL FIELD OF THE INVENTION

The present invention relates generally to a wire strain relief system. More particularly, the present invention relates to a terminal block having an integrated system for retaining wires to reduce strain on the wires when coupled to a terminal.

### BACKGROUND OF THE INVENTION

Terminal blocks are commonly used in various electronic devices for retaining one or more wires and electrical terminals. In current terminal blocks, the wires are typically soldered to the electrical terminals (creating a solder joint) and connected to or otherwise held in place on the terminal block by an adhesive. However, the adhesive can be difficult to accurately apply and the application tends to be inconsistent, which can result in the wires inadvertently separating from the terminal block and strain being placed on the solder joint. Such inadvertent separation and strain can cause damage to the wires and the solder joint to fatigue and fail during manufacturing and assembly and/or over time.

### SUMMARY OF THE INVENTION

The present invention relates broadly to wire strain relief systems that are incorporated into terminal blocks for electronic devices, where the wire strain relief systems reduce strain on wires and reduce the risk of damage to the wires and/or inadvertent separation of the wires from terminals of the terminal blocks. The wire strain relief systems may include support systems and/or structures to support the wires on the terminal blocks. For simplicity and ease of assembly and repair, the wire strain relief systems retain the wires in support structures that allow for sufficient support and retention of the wires, while still allowing for ease of installation and removal of the wires into and from the support structures as needed. By properly retaining and supporting the wires, stress and strain is reduced on the connections between the wires and the terminals (also referred to as wire terminal connections), without which the wire terminal connections may prematurely fail or otherwise break causing the electronic device to fail.

In an embodiment, the wire strain relief system may include a pair of opposing arms spaced from one another, where each of the arms includes a protrusion. In this embodiment, the pair of opposing arms are adapted to receive and retain the wire beneath the protrusions. In other embodiments, the wire strain relief system may include first and second sidewalls that cooperatively form a gap or channel therebetween. In these embodiments, the channel is sized to be smaller than an outer circumference of the wire such that the first and second sidewalls compress a compressible outer layer of a wire when the wire is disposed in the channel to retain the wire in the terminal block.

In an embodiment, the present invention broadly relates to a wire strain relief device for retaining a wire. The wire strain relief device may include a wire support portion including first and second elastic arms, wherein each of the first and second arms protrudes from a surface of a terminal block to cooperatively form a channel between the first and second arms. Each of the first and second arms may also include an inwardly extending protrusion with a tapered portion extending inwardly relative to the channel. The first and second arms and protrusions are adapted to cooperatively retain the wire in the channel.

In another embodiment, the present invention broadly relates to a terminal block that includes upper and lower surfaces. A first terminal is disposed proximate to the upper surface, and the terminal block includes a first wire support portion having first and second elastic arms protruding away from the upper surface and cooperatively forming a channel therebetween. The first and second arms may also respectively include protrusions that extend inwardly towards the channel. The first terminal is adapted to be electrically coupled to a wire connection end of a wire, and the wire support portion is adapted to receive and retain a wire body of the wire such that the wire body is cooperatively retained between the first and second arms and the protrusions.

In another embodiment, the present invention relates broadly to a method for relieving strain in a wire by retaining the wire within a wire strain relief device. The wire strain relief device may include first and second arms, wherein each of the first and second arms is adapted to protrude from a surface and has a protrusion that is adapted to cooperatively engage a wire therebetween.

In another embodiment, the present invention broadly relates to a terminal block with wire support portions. The terminal block includes upper and lower surfaces, and terminals are respectively disposed within slots proximate to the upper surface. The wire support portions includes first, second, and third wire support portions, where each of the first, second, and third wire support portions includes first and second elastic arms that protrude away from the upper surface and cooperatively form a channel therebetween. Each of the first and second arms also includes a protrusion that extends inwardly towards the channel. A first terminal of the terminals is adapted to be electrically coupled to a first wire connection end of a first wire, and the first and second elastic arms of the first wire support portion are adapted to receive and cooperatively retain a first wire body of the first wire in the channel between the first and second arms and the protrusions. Similarly, a second terminal of the terminals is adapted to be electrically coupled to a second wire connection end of a second wire, and the first and second elastic arms of the second wire support portion are adapted to receive and cooperatively retain a second wire body of the second wire in the channel between the first and second arms and the protrusions.

In another embodiment, the present invention broadly relates to a wire strain relief device for retaining a wire and having a surface including a wire support portion including first and second sidewalls, wherein each of the first and second sidewalls protrudes from the surface to cooperatively form a channel between the first and second sidewalls, and the channel is sized to be smaller than an outer circumference of the wire such that the first and second sidewalls compress a compressible outer layer of the wire when the wire is disposed in the channel to retain the wire therein.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an exemplar terminal block assembly, incorporating an embodiment of the present invention.

FIG. 2 is a perspective view of the terminal block assembly of FIG. 1 with terminals exploded from the exemplar terminal block assembly, incorporating an embodiment of the present invention.

FIG. 3 is a perspective view of the exemplar terminal block assembly of FIG. 1 with wires, incorporating an embodiment of the present invention.

FIG. 4 is a section view of an embodiment of a wire strain relief system of the present invention and a wire of the terminal block assembly of FIG. 1, taken along cutting line A-A of FIG. 3.

FIG. 5 is a perspective view of an exemplar terminal block assembly, incorporating another embodiment of the present invention.

FIG. 6 is a perspective view of the exemplar terminal block assembly of FIG. 5 with wires, incorporating an embodiment of the present invention.

FIG. 7 is a section view of an embodiment of a wire strain relief system of the present invention and a wire of the terminal block assembly of FIG. 5, taken along cutting line B-B of FIG. 6.

FIG. 8 is a perspective view of an exemplar terminal block assembly, incorporating another embodiment of the present invention.

FIG. 9 is a perspective view of the terminal block assembly of FIG. 8 with wires, incorporating an embodiment of the present invention.

FIG. 10 is a partial top view of an embodiment of a wire strain relief system according to the present invention and a wire of the terminal block assembly of FIG. 8, within the viewing plane C of FIG. 9.

### DETAILED DESCRIPTION OF THE INVENTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

The present invention relates broadly to a wire strain relief system that includes a wire support system or structure for retaining a wire to relieve and/or reduce stress and/or strain in the wire and a connection between the wire and a terminal. In an embodiment, the wire support structure includes a pair of arms protruding upward from a surface. Each of the arms includes a protrusion that extends inwardly at an angle relative to the arm. As a wire is inserted into the wire support structure, the wire abuts respective tapered portions of the protrusions, and, as the wire is continually pushed downwardly towards the surface, the arms elastically flex away from each other. When the wire passes through the protrusions, the arms elastically return to their neutral state, and the arms compressingly retain the wire in the wire support structure between the pair of arms and underneath each of the protrusions. The wire is electrically coupled to a terminal at one wire connection end and is electrically coupled to an external electronic device, such as, for example, a battery, a controller, a switch, or a sensor, at the other wire connection end.

In an embodiment, the wire support structure may be configured on a terminal block. The terminal block may house one or more terminals via a support mechanism, such as, for example, a slot formed through the terminal block. The terminals may also be integrated to the terminal block body by molding the terminals into the terminal block during the injection molding process, which may be referred to as insertion molding. One or more wires may be respectively routed towards and electrically coupled to terminals, where each of the wires is supported by one or more wire support structures to retain and relieve stresses and/or strains in the wire/terminal connection.

The wire support structures may help to prevent stress and/or strain on the wire and/or connection joint between the wire and the terminal by providing a controlled amount of slack or movement of the wire, and reduce the chances of the wire being inadvertently pulled from the terminal. This reduces the amount of relative motion between the wire and terminal block, such as when an object is assembled, handled, subject to external loading, dropped, thermally expanded or contracted, or various other uses which may cause stress or strain on the wire and terminal connection.

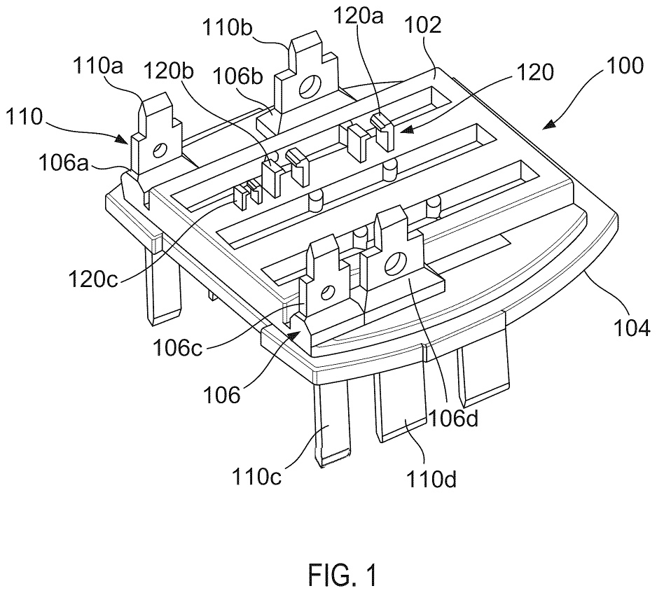

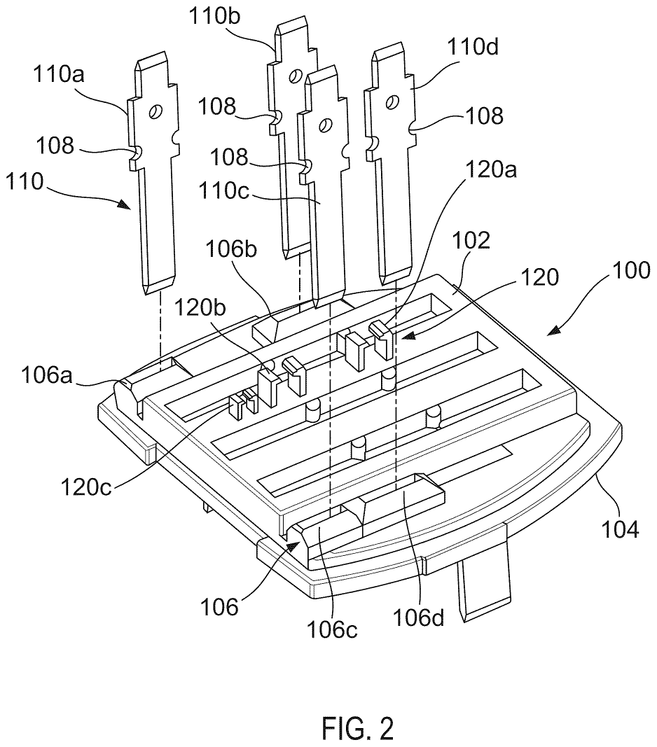

Referring to FIGS. 1-3, an embodiment of the present invention incorporated on a terminal block 100 is shown and described. The terminal block 100 includes an upper surface 102 and a lower surface 104. The terminal block 100 may include one or more support features 106 for respectively coupling one or more terminals 110 to the terminal block 100. As illustrated, the support feature 106 includes a slot formed between the upper surface 102 and lower surface 104 of the terminal block 100 which allows the terminal 110 to be inserted through the terminal block 100. In some embodiments, the terminal 110 is insert molded with the terminal block 100, such that the terminal block 100 is formed around the terminal 110 during the plastic injection molding process. As illustrated in FIG. 2, each of the terminals 110 may include one or more notches 108. When the terminal 110 is insert molded with the terminal block 100, material forming the terminal block 100 is molded around the notch(es) 108 to securely couple the terminal 110 to the terminal block 100.

It should be understood that the support feature 106 may be any suitable type of support feature, including, but not limited to, clips, slots, or any other suitable type of support feature adapted to receive a terminal 110. In yet further embodiments, external components such as fasteners or adhesives may be used to couple the terminal 110 to the terminal block 100. The terminal block 100 may be constructed of any suitable material, including, but not limited to, plastics and other polymers, such as molded plastics.

As illustrated, the terminal block 100 includes four support features 106 (such as, support features 106a, 106b, 106c, and 106d) respectively coupling four terminals 110 (such as, terminals 110a, 110b, 110c, and 110d) to the terminal block 100. However, it should be understood that the terminal block 100 may include any suitable number of support features 106 and terminals 110.

Each of the terminals 110 may be electrically coupled to external electronic devices, including, but not limited to, batteries, power packs, controllers, electric motors, switches, sensors, relays, or any other suitable electronic device.

One or more wire support portions 120 are formed on or in the upper surface 102 of the terminal block 100. As illustrated, the terminal block 100 includes three wire support portions 120 (such as, wire support portions 120a, 120b, and 120c).

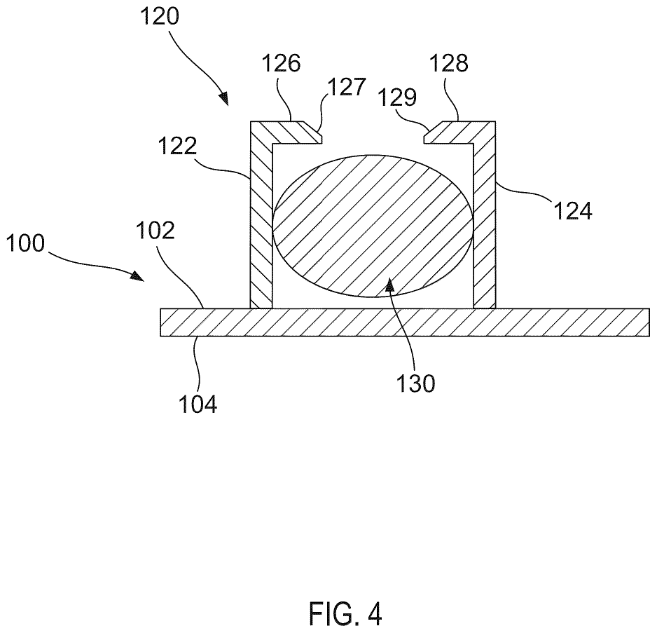

As illustrated in FIG. 4, each of the wire support portions 120 includes a first arm 122 and a second arm 124. Each of the first and second arms 122, 124 protrude upwardly from the upper surface 102 of the terminal block 100. The first and second arms 122, 124 may be formed and extend substantially perpendicular to the upper surface 102. The first and second arms 122, 124 may be spaced apart from each other so a channel is cooperatively formed therebetween.

In some embodiments, the first and second arms 122, 124 may be formed as a single piece with the terminal block 100, such as being molded as a single piece. In further embodiments, the first and second arms 122, 124 may be coupled to the terminal block 100, such as via plastic welding, adhesives, and/or fasteners.

The first arm 122 includes a first protrusion 126, and the second arm 124 includes a second protrusion 128. The first and second protrusions 126, 128 may be respectively angled away from the first and second arms 122, 124 towards the other of the arms 122, 124, such that the first and second protrusions 126, 128 overhang a portion of the channel formed between the first and second arms 122, 124. In some embodiments, each of the first and second protrusions 126, 128 are formed and extend substantially perpendicular relative to the respective first and second arms 122, 124. Each of the first and second protrusions 126, 128 may respectively have respective first and second tapered edges 127, 129.

While three wire support portions 120 (such as, 120a, 120b, and 120c) are shown, it will be understood that any suitable number of wire support portions 120 may be included. In some embodiments, one or more wires 130 may be supported by multiple wire support portions 120.

While the wire support portions 120 are illustrated as being configured on a terminal block 100, it will be understood that the wire support portions 120 may be configured for use on any suitable surface and/or environment, including, but not limited to, a housing of an electronic device, a printed circuit board (PCB), a test bench, or any other suitable surface and/or environment.

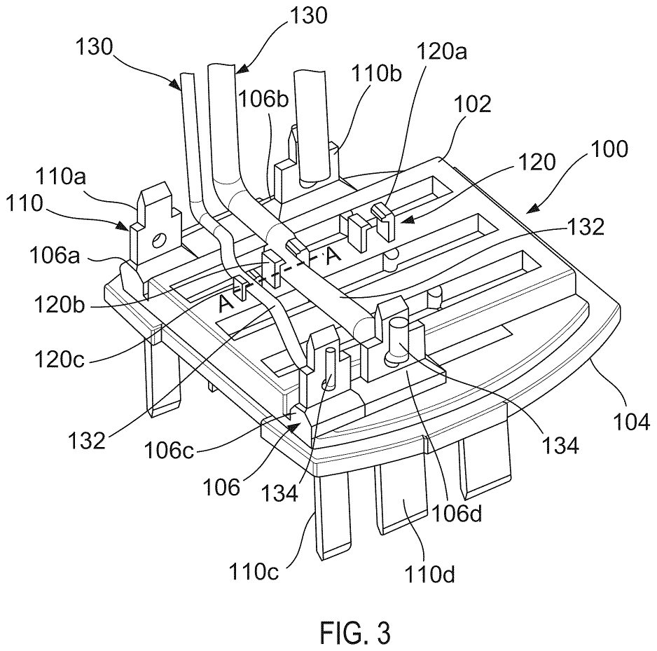

Referring now to FIG. 3, the terminal block 100 of FIGS. 1 and 2 is shown with multiple conventional wires 130 coupled thereto. Each of the wires 130 may be a conventional insulated wire with a wire body 132 and a wire connection end 134, where a portion of the insulation is removed from the wire connection end 134 to allow electrical connection of the wire 130 to a terminal 110 via the wire connection end 134 in a well-known manner. However, any suitable type of wire may be used.

When the wire 130 is inserted downwardly towards the surface into the wire support portion 120, the wire 130 abuts the first and second tapered edges 127, 129. As the wire is continually pushed downwardly towards the surface, downward force in cooperation with the first and second tapered edges 127, 129 causes the first and second arms 122, 124 to elastically deflect outwardly relative to one another. When the wire 130 passes the first and second protrusions 126, 128, the first and second arms 120, 122 elastically return to their neutral upright positions to compressingly retain the wire 130 therebetween.

The wire connection end 134 of the wire 130 is electrically coupled to at least one of the terminals 110. As illustrated, the wire connection end 134 is soldered to the terminal 110, however it should be understood that the wire connection end 134 may be electrically coupled to the terminal 110 by any suitable electrical coupling system, including but not limited to crimping, wire nuts, brazing, or any other suitable electrical coupling system. In yet further embodiments, the wire connection end 134 may include a connector which mates to the terminal 110.

The wire 130 may transmit electrical current from the terminal 110 to various external electronic devices, including but not limited to batteries, power packs, controllers, electric motors, switches, sensors, relays, or any other suitable electronic device.

In embodiments, the terminal block 100 may be adapted for use in any suitable electronic device, including but not limited to an electronic power tool such as a drill, an impact driver, or any other suitable type of electronic power tool. It should be understood that the terminal block 100 may further be adapted for use in other types of electronic devices as will be understood by a person of skill in the art.

Referring now to FIG. 4, a section view of the wire support portion 120b and the wire 130 along the cutting line A-A of FIG. 3 is shown. While wire support portion 120b is shown, it should be understood that any wire support portion 120 may have substantially similar features to those described in relation to wire support portion 120b.

The first and second arm s122, 124 extend perpendicular to the upper surface 102 of the terminal block 100. In further embodiments, it should be understood that each of the first and second arm s122, 124 may be formed at other suitable angles relative to the upper surface 102 of the terminal block 100. In yet further embodiments, the first and second arm s122, 124 may each be at different angles relative to the upper surface 102 of the terminal block 100.

The first protrusion 126 extends perpendicular to the first arm 122, and the second protrusion 128 extends perpendicular to the second arm 124. In further embodiments, both the first and second protrusions 126, 128 may be formed at any suitable angle relative to the first and second arms 122, 24, respectively. In yet further embodiments, the first protrusion 126 may be formed at an angle relative to the first arm 122 which is different than an angle between the second protrusion 128 and the second arm 124.

The wire 130 is retained between the first arm 122, the second arm 124, the first protrusion 126, the second protrusion 128, and the upper surface 102 of the terminal block 102. As illustrated, the wire 130 has a circular cross-sectional shape, but it should be understood that, in other embodiments, the wire support portion 120 may support wires with any suitable cross-sectional shape, including but not limited to a rectangle, an oval, or any other polygonal shape.

In some embodiments, at least one of the first and second arms 122, 124 may flex or deform outwardly when the wire 130 is disposed therein, so as to apply a compression force to the wire 130 to securely hold the wire 130 in place. In further embodiments, an outer layer of the wire 130, such as flexible insulation, may deform and be held by the first and second arms 122, 124.

The wire body 132 of the wire 130 is disposed within the channel defined in the wire support portion 120, and the first and second arms 122, 124 cooperatively retain the wire body 132 such that the wire body 132 is frictionally retained in the channel of the wire support portion 120 by the first and second arms 122, 124. The first and second protrusions 126, 128 may also further restrict the wire body 132 from moving vertically upwardly relative to the terminal block 100. By restricting the wire 130 from moving relative to the terminal block 100, stress and/or strain on the wire 130 and connection joint between the terminal 110 and the wire connection end 134 may be reduced, compared to terminal blocks without wire support portions 120.

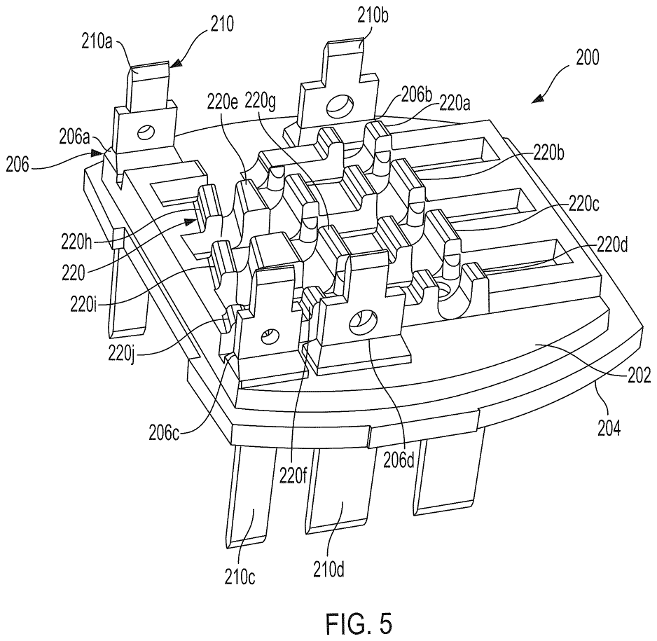

Referring now to FIG. 5, another terminal block 200 is shown. The terminal block 200 is similar to the terminal block 100, and includes an upper surface 202 and a lower surface 204. The terminal block 200 may include one or more support features 206 for respectively coupling one or more terminals 210 to the terminal block 200. As illustrated, the support feature 206 may include a slot formed between the upper surface 202 and lower surface 204 of the terminal block 200 which allows the terminal 210 to be inserted through the terminal block 200. In some embodiments, the terminal 210 is insert molded with the terminal block 200 (as described above with respect to terminal block 100 and terminal 110), such that the terminal block 200 is formed around the terminal 210 during the plastic injection molding process.

It should be understood that the support feature 206 may be any suitable type of support feature, including, but not limited to, clips, slots, or any other suitable type of support feature. In yet further embodiments, external components such as fasteners or adhesives may be used to couple the terminal 210 to the terminal block 200. The terminal block 200 may be constructed of any suitable material, including, but not limited to, plastics and other polymers, such as molded plastics.

As illustrated, the terminal block 200 includes four support features 206 (such as, support features 206a, 206b, 206c, and 206d) respectively coupling terminals 210 (such as terminals 210a, 210b, 210c, and 210d) to the terminal block 200. However, it should be understood that the terminal block 200 may include any suitable number of support features 206 and terminals 210.

Each of the terminals 210 may be electrically coupled to external electronic devices, including, but not limited to, batteries, power packs, controllers, electric motors, switches, sensors, relays, or any other suitable electronic device.

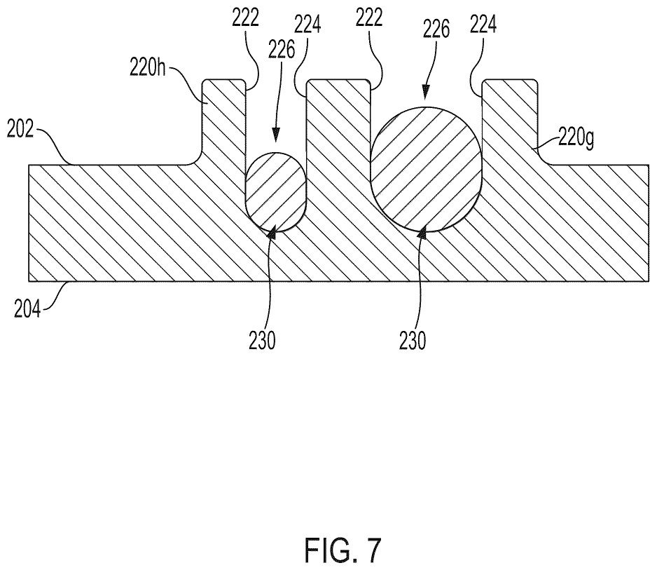

One or more wire support portions 220 are formed on the upper surface 202 of the terminal block 200. As illustrated, the terminal block 200 includes ten wire support portions 220 (such as, wire support portions 220a-220j). However, it should be understood that the terminal block 200 may include any suitable number of wire support portions 220. As shown in FIG. 7, each of the wire support portions 220 includes a first sidewall 222 and a second sidewall 224, and a channel 226 formed between the first and second sidewalls 222, 224.

In some embodiments, the first and second sidewalls 222, 224 may be formed as a single piece with the terminal block 200, such as being molded as a single piece. In further embodiments, the first and second sidewalls 222, 224 may be coupled to the terminal block 200, such as via plastic welding, adhesives, and or fasteners.

While the wire support portions 220 are illustrated as being configured on a terminal block 200, it should be understood that, in embodiments, the wire support portions 220 may be configured for use on any suitable surface and/or environment, including but not limited to a housing of an electronic device, a printed circuit board (PCB), a test bench, or any other suitable surface and/or environment.

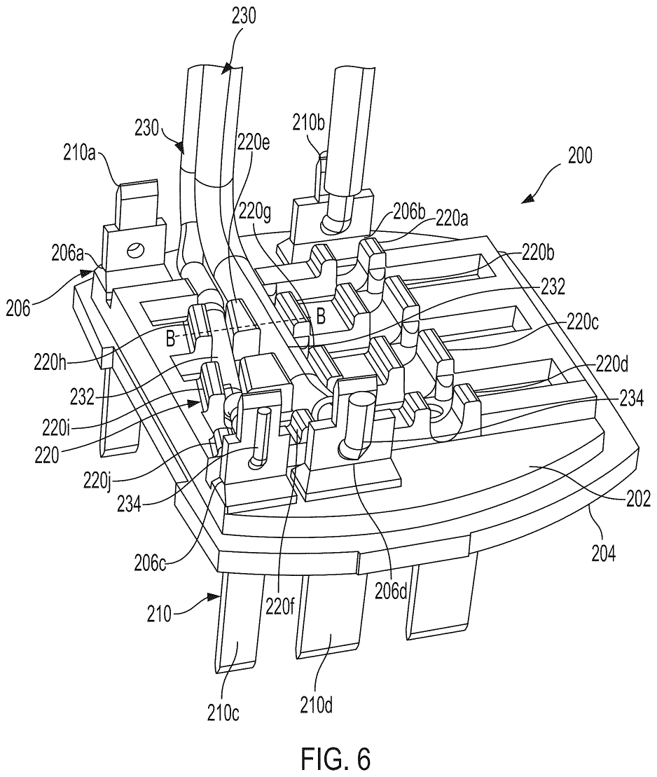

Referring now to FIG. 6, the terminal block 200 with multiple wires 230 coupled thereto is shown. Each of the wires 230 may be an insulated wire with a wire body 232 and a wire connection end 234, where a portion of the insulation is removed from the wire connection end 234 to allow electrical connection of the terminal 210 to the wire 230 via the wire connection end 234. However, any suitable type of wire may be used. The insulation on the wire body 232 of the wire 230 may also be constructed of a compressible material, such as rubber, polymer, or other suitable material.

The wire body 232 may be disposed within the wire support portion 220, such that the first and second sidewalls 222, 224 compressingly retain the wire body 232 between the first and second sidewalls 222, 224 as the insulation of the wire body 232 is compressed within the channel 226. In this regard, the channel 226 may be slightly smaller than an outer circumference of the wire 230 to allow for the first and second sidewalls 222, 224 to compress the wire body 232. By restricting the wire 230 from moving relative to the terminal block 200, stress and/or strain on the wire 230 and connection joint between the terminal 210 and the wire connection end 234 may be reduced, compared to terminal blocks without wire support portions 220.

The wire connection end 234 is electrically coupled to at least one of the terminals 210. As illustrated, the wire connection end 234 is soldered to the terminal 210; however, it should be understood that the wire connection end 234 may be electrically coupled to the terminal 210 by any suitable electrical coupling system, including but not limited to crimping, wire nuts, brazing, or any other suitable electrical coupling system. In yet further embodiments, the wire connection end 234 may include a connector which mates to the terminal 210.

The wire 230 may transmit electrical current from the terminal 210 to various external electronic devices, including but not limited to batteries, power packs, controllers, electric motors, switches, sensors, relays, or any other suitable electronic device.

In embodiments, the terminal block 200 may be adapted for use in any suitable electronic device, including, but not limited to, an electronic power tool such as a drill, an impact driver, or any other suitable type of electronic power tool. It should be understood that the terminal block 200 may further be adapted for use in other types of electronic devices as will be understood by a person of skill in the art.

Referring now to FIG. 7, a section view of the wire support portion 220h and 220g along cutting line B-B of FIG. 6 is shown. While the wire support portions 220h and 220g are shown, it should be understood that any wire support portion 220 may have substantially similar features to those described in relation to wire support portions 220h and 220g.

When the wire 230 is inserted downwardly towards the surface into the channel 226, the insulation on the wire body 232 of the wire 230 is compressed by the first and second sidewalls 222, 224 so that the wire 230 is compressingly retained in the wire support portion 220.

As illustrated, the wire 230 has a circular cross-sectional shape, but it should be understood that, in embodiments, the wire support portion 220 may support wires with any suitable cross-sectional shape, including but not limited to a rectangle, an oval, or any other suitable shape.

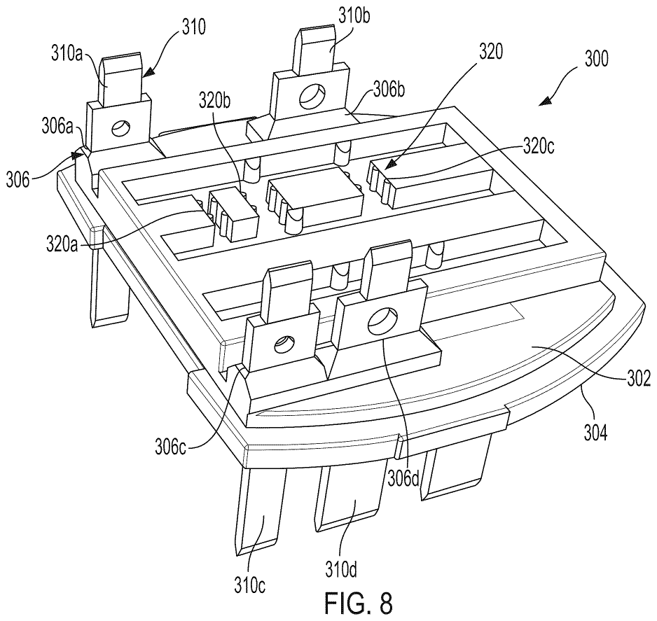

Referring now to FIG. 8, another terminal block 300 is shown. The terminal block 300 is similar to the terminal blocks 100, 200, and includes an upper surface 302 and a lower surface 304. The terminal block 300 may include one or more support features 306 for respectively coupling one or more terminals 310 to the terminal block 300. As illustrated, the support feature 306 includes a slot formed between the upper surface 302 and lower surface 304 of the terminal block 300 which allows the terminal 310 to be inserted through the terminal block 300. In some embodiments, the terminal 310 is insert molded with the terminal block 300 (as described above with respect to terminal block 100 and terminal 110), such that the terminal block 300 is formed around the terminal 310 during the plastic injection molding process.

It should be understood that the support feature 306 may be any suitable type of support feature, including, but not limited to, clips, slots, or any other suitable type of support feature. In yet further embodiments, external components such as fasteners or adhesives may be used to couple the terminal 310 to the terminal block 300. The terminal block 300 may be constructed of any suitable material, including, but not limited to, plastics and other polymers, such as molded plastics.

As illustrated, the terminal block 300 includes four support features 306 (such as, support features 306a, 306b, 306c, and 306d) respectively coupling terminals 310 (such as terminals 310a, 310b, 310c, and 310d) to the terminal block 300. However, it should be understood that the terminal block 300 may include any suitable number of support features 306.

Each of the terminals 310 may be electrically coupled to external electronic devices, including, but not limited to, batteries, power packs, controllers, electric motors, switches, sensors, relays, or any other suitable electronic device.

One or more wire support portions 320 are formed on the upper surface 302 of the terminal block 300. As illustrated, the terminal block 300 includes three wire support portions 320 (such as, wire support portions 320a, 320b, and 320c). However it should be understood that, in embodiments, the terminal block 300 may include any suitable number of wire support portions 320.

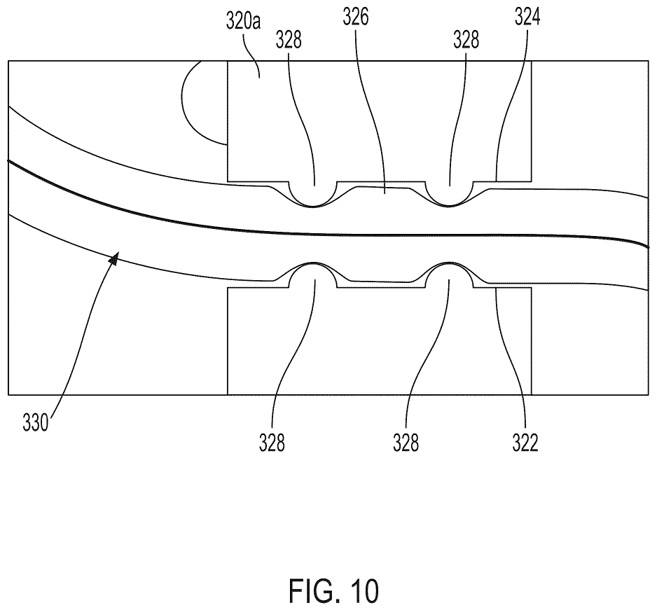

As shown in FIG. 10, each of the wire support portions 320 includes a first sidewall 322 and a second sidewall 324, and a channel 326 is formed between the first and second sidewalls 322, 324. One or more inwardly protruding ridges 328 may also be formed on each of the first and second sidewalls 322, 324, and project inwardly into the channel 326.

In some embodiments, the first and second sidewalls 322, 324 may be formed as a single piece with the terminal block 300, such as being molded as a single piece. In further embodiments, the first and second sidewalls 322, 324 may be coupled to the terminal block 300, such as via plastic welding, adhesives, and/or fasteners.

While the wire support portions 320 are illustrated as being configured on a terminal block 300, it should be understood that the wire support portions 320 may be configured for use on any suitable surface and/or environment, including but not limited to a housing of an electronic device, a printed circuit board (PCB), a test bench, or any other suitable surface and/or environment.

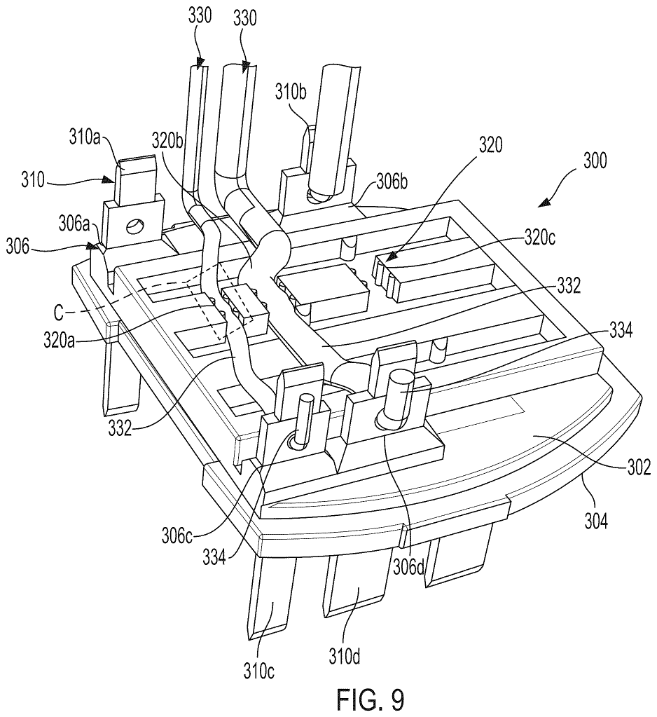

Referring now to FIG. 9, the terminal block 300 of FIG. 8 with multiple wires 330 coupled thereto is shown. Each of the wires 330 may be an insulated wire with a wire body 332 and a wire connection end 334, where a portion of the insulation is removed from the wire connection end 334 to allow electrical connection of the wire 330 to a terminal 310 via the wire connection end 334. However, any suitable type of wire may be used. The insulation on the wire body 332 of the wire 330 may also be constructed of a compressible material such as rubber, polymer, or other suitable material.

The wire body 332 is disposed within the wire support portion 320, such that the ridges 328 of the first and second sidewalls 322, 324 compressibly retain the wire body 332 between the first and second sidewalls 322, 324 as the insulation of the wire body 332 is compressed by the ridges 328. In this regard, ridges 328 extend inwardly into the channel 326 and cause a space between opposing ridges 328 to be smaller than an outer circumference of the wire 330 to allow for the first and second sidewalls 322, 324 to compress the wire body 332. By restricting the wire 330 from moving relative to the terminal block 300, stress and/or strain on the wire 330 and connection joint between the terminal 310 and the wire connection end 334 may be reduced, compared to terminal blocks without wire support portions 320.

The wire connection end 334 is electrically coupled to at least one of the terminals 310. As illustrated, the wire connection end 334 is soldered to the terminal 310; however, it should be understood that the wire connection end 334 may be electrically coupled to the terminal 310 by any suitable electrical coupling system, including but not limited to crimping, wire nuts, brazing, or any other suitable electrical coupling system. In yet further embodiments the wire connection end 334 may include a connector which mates to the terminal 310.

The wire 330 may transmit electrical current from the terminal 310 to various external electronic devices, including but not limited to batteries, power packs, controllers, electric motors, switches, sensors, relays, or any other suitable electronic device.

In embodiments, the terminal block 300 may be adapted for use in any suitable electronic device, including but not limited to an electronic power tool such as a drill, an impact driver, or any other suitable type of electronic power tool. It should be understood that the terminal block 300 may further be adapted for use in other types of electronic devices as will be understood by a person of skill in the art.

Referring now to FIG. 10, a partial top view within viewing plane C of the wire support portion 320 is shown with a segment of the wire 330 disposed therein. While the wire support portion 320a is shown, it should be understood that any wire support portion 320 may have substantially similar features to those described in relation to wire support portion 320a.

Each of the first and second sidewalls 322, 324 includes one or more ridges 328 that project or otherwise extends inwardly into the channel 326. When the wire 330 is inserted downwardly into the channel 326, the ridges 328 cause the insulation on the wire body 332 to compress to compressibly retain the wire 330 in the wire support portion 320.

As illustrated, each of the first and second sidewalls 322, 324 includes two ridges 328 projecting therefrom. However, it should be understood that any suitable number of ridges 328 may project from any of the first and second sidewalls 322, 324.

As used herein, the term “coupled” can mean any physical, electrical, magnetic, or other connection, either direct or indirect, between two parties. The term “coupled” is not limited to a fixed direct coupling between two entities.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors'contribution. The actual scope of the protection sought is intended to be defined in the following claims when viewed in their proper perspective based on the prior art.

What is claimed is:

1. A wire strain relief device for retaining a wire, the wire strain relief device comprising:
a wire support portion including first and second elastic arms, and a channel formed between the first and second arms, wherein each of the first and second arms includes a protrusion that extends inwardly relative to the channel, and the protrusions respectively have tapered portions, wherein the first and second arms and protrusions are adapted to cooperatively retain the wire in the channel.

2. The wire strain relief device of claim 1, wherein each of the first and second arms protrude substantially perpendicular relative to a surface of the wire strain relief device.

3. The wire strain relief device of claim 1, wherein the first and second protrusions respectively extend substantially perpendicularly relative to the first and second arms.

4. The wire strain relief device of claim 1, further comprising a plurality of wire support portions.

5. The wire strain relief device of claim 1, further comprising a wire disposed in the wire strain relief device and cooperatively retained by the first and second arms and protrusions, wherein the wire is electrically connected to a terminal.

6. The wire strain relief device of claim 5, wherein a wire connection end of the wire is soldered to the terminal.

7. A terminal block including upper and lower surfaces, the terminal block comprising:
a first terminal disposed proximate to the upper surface and adapted to be electrically coupled to a wire connection end of a wire; and
a first wire support portion having first and second elastic arms protruding away from the upper surface and cooperatively forming a channel therebetween, wherein the first and second arms respectively include protrusions extending inwardly relative to the channel, and the first and second arms and the protrusions are adapted to receive and cooperatively retain the wire.

8. The terminal block of claim 7, further comprising a second wire support portion.

9. The terminal block of claim 8, wherein second wire support portion is adapted to receive and retain the wire.

10. The terminal block of claim 7, further comprising a second terminal disposed proximate to the terminal block upper surface.

11. The terminal block of claim 7, wherein the first terminal is adapted to be soldered to the wire connection end.

12. The terminal block of claim 7, wherein each of the first and second arms is substantially perpendicular to the upper surface.

13. The terminal block of claim 7, wherein the first and second protrusions are respectively substantially perpendicular to the first and second arms.

14. The terminal block of claim 7, wherein each of the first and second protrusions includes a tapered portion.

15. The terminal block of claim 7, wherein the first terminal is disposed in a slot formed in the terminal block upper surface.

16. The terminal block of claim 7, wherein the terminal block is molded around the first terminal in an injection molding process.

17. A terminal block comprising:
upper and lower surfaces;
terminals coupled to the terminal block; and
first, second, and third wire support portions, wherein each of the first, second, and third wire support portions includes first and second elastic arms protruding away from the upper surface and cooperatively forming a channel therebetween, and the first and second arms respectively include protrusions extending inwardly towards the channel;
wherein a first terminal of the terminals is adapted to be electrically coupled to a first wire connection end of a first wire and the first and second arms and the protrusions of the first wire support portion are adapted to receive and cooperatively retain a first wire body of the first wire, and
a second terminal of the terminals is adapted to be electrically coupled to a second wire connection end of a second wire and the first and second arms and the protrusions of the second wire support portion are adapted to receive and cooperatively retain a second wire body of the second wire.

18. The terminal block of claim 17, wherein the terminal block is at least partially molded around the terminals with exposed portions of the terminals disposed above the upper surface and below the lower surface.

19. A wire strain relief device for retaining a wire, the wire strain relief device comprising:
a wire support portion including first and second sidewalls and a channel formed between the first and second sidewalls, wherein the channel has a size that is smaller than an outer circumference of the wire, and the first and second sidewalls are adapted to compress a compressible outer layer of the wire when the wire is disposed in the channel.

20. The wire strain relief device of claim 19, further comprising a ridge formed on each of the first and second sidewalls and extending inwardly into the channel, wherein the ridges are adapted to compress the compressible outer layer of the wire when the wire is disposed in the channel.

21. The wire strain relief device of claim 19, further comprising a plurality of wire support portions.
